(19) United States
(12) Patent Application Publication
(10) Pub. No.: US 2008/0084384 A1
(43) Pub. Date: Apr. 10, 2008

(54) Multiple Mode Haptic Feedback System

(75) Inventors: Pedro Gregorio, Verdun (CA); Danny A. Grant, Montreal (CA); Juan Manuel Cruz-Hernandez, Montreal (CA)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Immersion Corporation, San Jose, CA (US)

(21) Appl. No.: 11/735,096

(22) Filed: Apr. 13, 2007

Related U.S. Application Data
(60) Provisional application No. 60/828,368, filed on Oct. 5, 2006.

(51) Int. Cl. G09G 5/00

(52) U.S. Cl. 345/156

(57) ABSTRACT

A haptic effect device includes a housing and a touchscreen coupled to the housing through a suspension. An actuator is coupled to the touchscreen. The suspension is tuned so that when the actuator generates first vibrations at a first frequency, the first vibrations are substantially isolated from the housing and are applied on the touchscreen to simulate a mechanical button. Further, when the actuator generates second vibrations at a second frequency, the second vibrations are substantially passed through to the housing to create a vibratory alert.

### RELATED APPLICATIONS

This application claims the benefit of U.S. Provisional Patent Application No. 60/828,368 filed Oct. 5, 2006.

### FIELD OF THE INVENTION

One embodiment is directed to a haptic feedback system. More particularly, one embodiment is directed to a multiple mode haptic feedback system.

### BACKGROUND INFORMATION

Electronic device manufacturers strive to produce a rich interface for users. Conventional devices use visual and auditory cues to provide feedback to a user. In some interface devices, kinesthetic feedback (such as active and resistive force feedback) and/or tactile feedback (such as vibration, texture, and heat) is also provided to the user, more generally known collectively as “haptic feedback.” Haptic feedback can provide cues that enhance and simplify the user interface. Specifically, vibration effects, or vibrotactile haptic effects, may be useful in providing cues to users of electronic devices to alert the user to specific events, or provide realistic feedback to create greater sensory immersion within a simulated or virtual environment.

Haptic feedback has also been increasingly incorporated in portable electronic devices, such as cellular telephones, personal digital assistants (PDAs), portable gaming devices, and a variety of other portable electronic devices. For example, some portable gaming applications are capable of vibrating in a manner similar to control devices (e.g., joysticks, etc.) used with larger-scale gaming systems that are configured to provide haptic feedback. Additionally, devices such as cellular telephones and PDAs are capable of providing various alerts to users by way of vibrations. For example, a cellular telephone can alert a user to an incoming telephone call by vibrating. Similarly, a PDA can alert a user to a scheduled calendar item or provide a user with a reminder for a “to do” list item or calendar appointment.

For portable devices, costs is an important driving factor. Therefore, to generate haptic effects a single low cost actuator is generally used, for example an eccentric rotating mass (“ERM”) motor or an electromagnetic motor. Typically, vibrations output by standard portable electronic devices, such as PDAs and cellular telephones, are simple vibrations that are applied to the housing of the portable device, which operate as binary vibrators that are either on or off to typically create an alert. That is, the vibration capability of those devices is generally limited to a full-power vibration (a “fully on” state), or a rest state (a “fully off”). Thus, generally speaking, there is little variation in the magnitude of vibrations that can be provided by such devices.

Increasingly, portable devices are moving away from physical buttons in favor of touchscreen-only interfaces. This shift allows increased flexibility, reduced parts count, and reduced dependence on failure-prone mechanical buttons and is in line with emerging trends in product design. When using the touchscreen input device, a mechanical confirmation on button press or other user interface action can be simulated with haptics. In order to be effective and pleasing to a user, the haptics used to simulate the buttons should typically be applied primarily to the touchscreen rather than the housing. However, the single actuator typically provided with portable devices cannot usually generate haptic effects to generate alerts on the housing and to also generate other haptic effects to, e.g., simulate a touchscreen button, on the touchscreen. Thus, one or more additional actuators are required to create the required multiple haptic effects. Unfortunately, this increases the costs of the portable device.

Based on the foregoing, there is a need for a system and method for generating multiple haptic effects using a single actuator.

### SUMMARY OF THE INVENTION

One embodiment is a haptic effect device that includes a housing and a touchscreen coupled to the housing through a suspension. An actuator is coupled to the touchscreen. The suspension is tuned so that when the actuator generates first vibrations at a first frequency, the first vibrations are substantially isolated from the housing and are applied on the touchscreen to simulate a mechanical button. Further, when the actuator generates second vibrations at a second frequency, the second vibrations are substantially passed through to the housing to create a vibratory alert.

### BRIEF DESCRIPTION OF THE DRAWINGS

FIG. 1 is a sectional view of a cellular telephone in accordance with one embodiment.

FIG. 2 is a graph of acceleration magnitude vs. drive signal frequency that illustrates the frequency response of the telephone after tuning a suspension in accordance with one embodiment.

FIG. 3 is a graph of acceleration magnitude vs. time for one embodiment for a click vibration frequency.

FIG. 4 is a graph of acceleration magnitude vs. time for the same embodiment of FIG. 3 for an alert vibration frequency.

### DETAILED DESCRIPTION

One embodiment is a device that includes a touchscreen coupled to a device housing by a suspension. A single actuator creates a haptic effect vibration that is substantially applied only to the touchscreen in one mode, and is applied to the housing in another mode.

One type of haptic effect that is typically provided on handheld portable touchscreen devices is an “alert” vibration applied to the device housing. Alert vibrations are effective when played in the 100 Hz-200 Hz frequency range. An alert is a vibratory method to notice a user of a present, future or past event. Such an alert can be a ringtone signaling an incoming call where the ringtone has been converted to a vibratory equivalent to play on the handheld device. An alert can be to notice a user of a dropped call, for ringing, busy and call waiting. Other examples of alerts include operational cues to guide the user through an operation such as for Send/OK with a different feel for each menu and message navigation for scrolling down a screen and to feel the difference between opened and unopened messages. Further, for cellular phones with GPS tracking, a proximity sensing application to determine a distance from a designated geographic location can generate an alert.

Another type of haptic effect that is typically provided on handheld portable touchscreen devices is a “click” vibration effect applied to the touchscreen to simulate a press of a button. Measurements of traditional mechanical buttons shows that a pleasing and satisfying button feel is characterized by short, crisp vibrations in the approximate >200 Hz range. In order to be most effective, the haptic vibration effect should be applied primarily to the touchscreen rather than the housing.

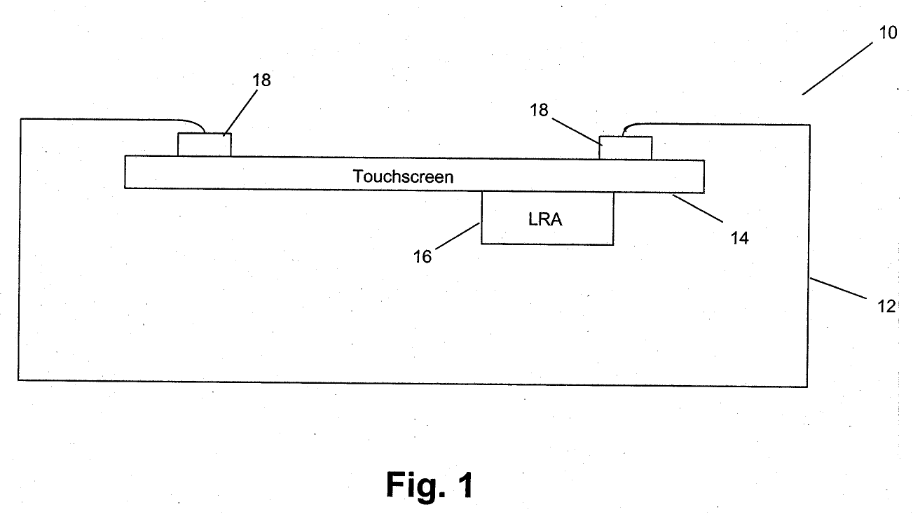

FIG. 1 is a sectional view of a cellular telephone 10 in accordance with one embodiment. Telephone 10 includes a touchscreen 14 that displays telephone keys and other functional keys that can be selected by a user through the touching or other contact of touchscreen 14. Telephone 10 further includes a housing or body 12 that encloses the internal components of telephone 10 and supports touchscreen 14. When a user uses telephone 10, the user will typically hold telephone 10 by housing 12 in one hand while touching touchscreen 14 with another hand. Other embodiments are not cellular telephones and do not have touchscreens but are haptic devices with other types of input interfaces. Other input interfaces besides touchscreens may be a mini-joystick, scroll wheel, d-Pad, keyboard, touch sensitive surface, etc. As with a cellular telephone, for these devices there is a desire for a click sensation linked to the input interface and an alert vibration created on the entire device.

Touchscreen 14 is flexibly suspended/floated or mounted on housing 12 by a suspension 18 that surrounds touchscreen 14. In one embodiment, suspension 18 is formed from a viscoelastic bezel seal gasket made of a foam material such as PORON®. In other embodiments, any other type of material can be used for suspension 18 as long as it can be “tuned” as disclosed below.

A Linear Resonant Actuator (“LRA”) or other type of actuator 16 (e.g., Shape Memory alloys, Electroactive polymers, Piezoelectric, etc.) is rigidly coupled to touchscreen 14. An LRA includes a magnetic mass that is attached to a spring. The magnetic mass is energized by a electrical coil and is driven back and forth against the spring in a direction perpendicular to touchscreen 14 to create a vibration. In one embodiment, actuator 16 has a resonant frequency of approximately 150 Hz-190 Hz. The resonant frequency is the frequency range where the acceleration responsiveness is at its peak. A controller/processor, memory device, and other necessary components (not shown) are coupled to actuator 16 in order to create the signals and power to actuator 16 to create the desired haptic effects. Different haptic effects can be generated by actuator 16 in a known manner by varying the frequency, amplitude and timing of the driving signal to actuator 16. Vibrations may be perpendicular to touchscreen 14 or in another direction (e.g., in-plane). In one embodiment, vibrations along the screen surface (X or Y vibrations) are advantageous as they produce equivalent haptic information and also are distributed more evenly over the entire touchscreen due to inherent stiffness of the screen in those directions.

In one embodiment, suspension 18 is tuned so that it isolates housing 12 of device 10 from vibrations at the click frequency (>200 Hz) that are applied to touchscreen 14 to simulate button presses, but effectively passes vibrations to housing 12 at the alert frequency (˜150 Hz), which should be approximately equal to the resonant frequency of actuator 16, to create alert haptic effects. Suspension 18 can be tuned by, for example, varying the selection of material to get a desired property, varying the total cross-sectional area, varying the thickness, etc.

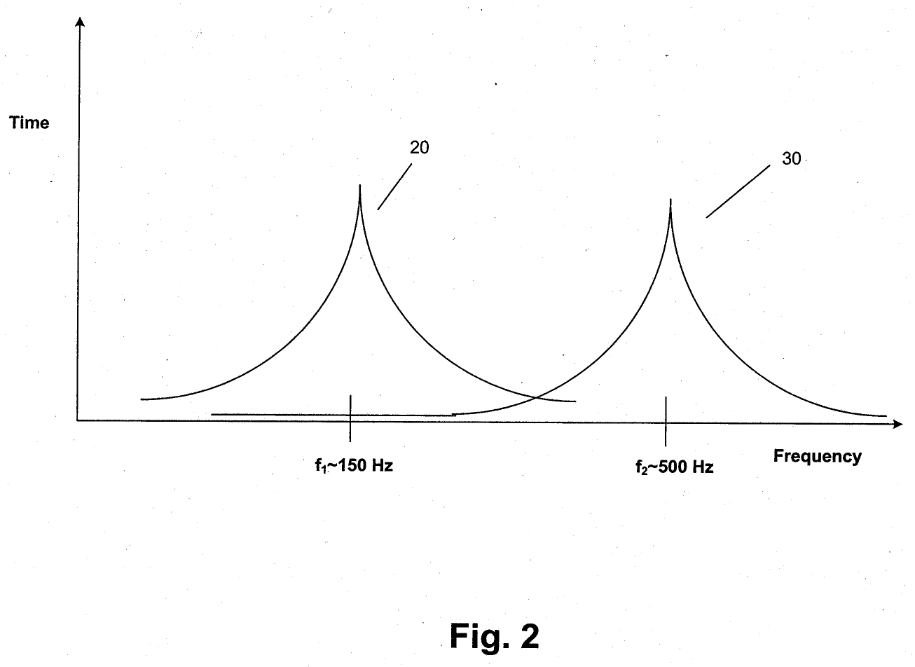

FIG. 2 is a graph of acceleration magnitude vs. drive signal frequency that illustrates the frequency response of telephone 10 after tuning suspension 18 in accordance with one embodiment. Curve 20 is the frequency response measured on housing 12 and indicates a resonant frequency (f₁) at the alert frequency (˜150 Hz). Curve 30 is the frequency response measured on touchscreen 14 and indicates a resonant frequency (f₂) at the click frequency (>200 Hz or ˜500 Hz).

In operation, haptic effect vibrations can selectively be played as click vibrations to touchscreen 14 only, while being substantially isolated from housing 12 by suspension 18, in the case of key-press confirmations, by playing the effects at the click frequency. Similarly, haptic effect vibrations can be selectively played as alert vibrations with vibrations that pass through to housing 12 with substantially no attenuation by playing the effects at the alert frequency.

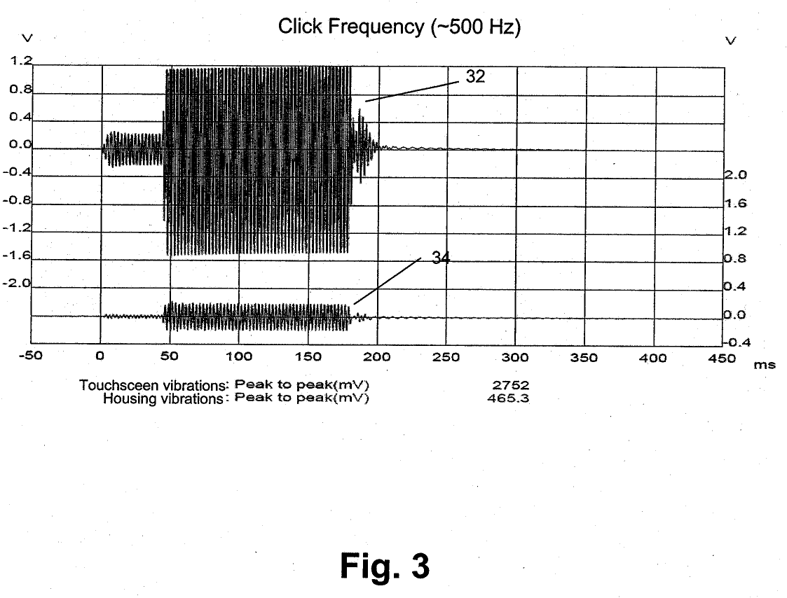

FIG. 3 is a graph of acceleration magnitude vs. time for one embodiment for a click frequency (>200 Hz). In the embodiment of FIG. 3, touchscreen 14 is suspended using two strips of PORON®, one along each edge, and an LRA with a resonant frequency of ˜155 Hz. Trace 32, which uses the scale on the left side of the graph, indicates accelerometer readings on touchscreen 14. Trace 34, which uses the scale on the right side of the graph, indicates accelerometer readings on housing 12 on the back of telephone 10.

As shown, the vibration is predominantly experienced through the touchscreen by the pressing finger compared to through the housing by the supporting hand (5:1 acceleration ratio). Moreover, the click vibrations are fast reaching peak values ˜3 ms after the start of the drive signal and decaying ˜5 ms after the onset of braking. This is ideal for creating a crisp mechanical button feel.

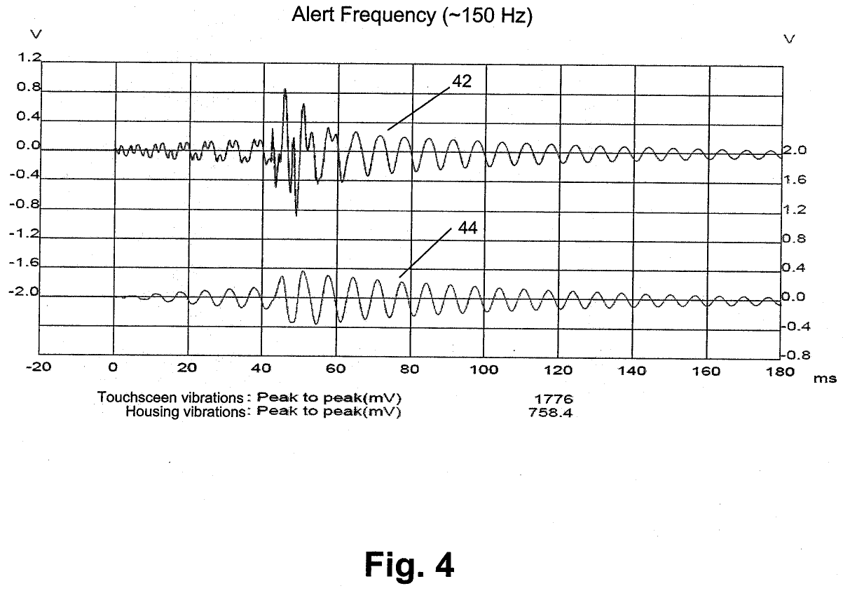

FIG. 4 is a graph of acceleration magnitude vs. time for the same embodiment of FIG. 3 for an alert vibration frequency (˜150 Hz). Trace 42, which uses the scale on the left side of the graph, indicates accelerometer readings on touchscreen 14. Trace 44, which uses the scale on the right side of the graph, indicates accelerometer readings on housing 12 on the back of telephone 10. Notwithstanding the touchscreen isolation through suspension 18, the alert vibrations pass through to housing 12 and are experienced by the supporting hand almost without attenuation. This is ideal for creating effective alerts.

Several embodiments are specifically illustrated and/or described herein. However, it will be appreciated that modifications and variations of the present invention are covered by the above teachings and within the purview of the appended claims without departing from the spirit and intended scope of the invention.

For example, some embodiments disclosed above are implemented as a cellular telephone with a touchscreen, which is an object that can be grasped, gripped or otherwise physically contacted and manipulated by a user. As such, the present invention can be employed on other haptics enabled input and/or output devices that can be similarly manipulated by the user and may require two modes of haptic effects. Such other devices can include other touchscreen devices (e.g., a Global Positioning System (“GPS”) navigator screen on an automobile, an automated teller machine (“ATM”) display screen), a remote for controlling electronics equipment (e.g., audio/video, garage door, home security, etc.) and a gaming controller (e.g., joystick, mouse, gamepad specialized controller, etc.). The operation of such input and/or output devices is well known to those skilled in the art.

What is claimed is:

1. A haptic device comprising:
a housing;
an input interface coupled to said housing through a suspension; and
an actuator coupled to said input interface;
wherein said suspension is adapted so that when said actuator generates first vibrations at a first frequency, said first vibrations are substantially isolated from said housing, and when said actuator generates second vibrations at a second frequency, said second vibrations are substantially passed through to said housing.

2. The device of claim 1, wherein said first frequency is greater than said second frequency.

3. The device of claim 1, wherein said first frequency is approximately >200 Hz.

4. The device of claim 1, wherein said second frequency is approximately 100 Hz-200 Hz.

5. The device of claim 1, wherein said actuator is a Linear Resonant Actuator.

6. The device of claim 1, wherein said suspension comprises a foam material.

7. The device of claim 6, wherein said foam material comprises PORON®.

8. The device of claim 1, wherein said first vibrations are substantially applied on said input interface in response to contact on said input interface.

9. The device of claim 8, wherein said first vibrations simulate a mechanical button.

10. The device of claim 1, wherein said second vibrations provide an alert.

11. The device of claim 1, wherein said input interface is a touchscreen.

12. A method of operating a device comprising a housing and an input interface, said method comprising:
generating a first vibration at a first frequency by an actuator, wherein said first vibration is substantially isolated from said housing by a suspension coupled to said input interface; and
generating a second vibration at a second frequency by the actuator, wherein said second vibration is substantially passed through to said housing.

13. The method of claim 12, wherein the first frequency is approximately >200 Hz.

14. The method of claim 12, wherein the second frequency is approximately 100 Hz-200 Hz.

15. The method of claim 12, wherein generating the first vibration is in response to the detection of contact on the input interface.

16. The method of claim 15, wherein said first vibration simulates a mechanical button.

17. The method of claim 12, wherein generating the second vibration is in response to a need to provide an alert.

18. The method of claim 12, wherein said input interface is a touchscreen.

19. The method of claim 12, wherein said first vibration is greater than said second vibration.

20. A handheld device comprising:
a housing;
an input interface coupled to said housing;
a suspension coupled to said housing;
an actuator coupled to said input interface; and
a controller coupled to said actuator adapted to generate a first vibration at a first frequency and a second vibration at second frequency;
wherein said suspension is adapted to substantially isolate the first vibration from said housing, and substantially apply the second vibration on said housing.

21. The device of claim 20, wherein said first frequency is approximately >200 Hz.

22. The device of claim 20, wherein said second frequency is approximately 100 Hz-200 Hz.

23. The device of claim 20, wherein said actuator is a Linear Resonant Actuator.

24. The device of claim 20, wherein said suspension comprises a foam material.

25. The device of claim 24, wherein said foam material comprises PORON®.

26. The device of claim 20, wherein said first vibration is substantially applied on said input interface in response to contact on said input interface.

27. The device of claim 26, wherein said first vibration simulates a mechanical button.

28. The device of claim 27, wherein said second vibration provides an alert.

29. The device of claim 20, wherein said input interface is a touchscreen.

30. The device of claim 20, wherein said first vibration is greater than said second vibration.

31. A handheld device comprising:
a housing;
an input interface coupled to said housing;
a suspension coupled to said housing;
an actuator coupled to said input interface; and
means for generating a first vibration at a first frequency by said actuator, wherein said first vibration is substantially isolated from said housing; and
means for generating a second vibration at a second frequency by said actuator, wherein said second vibration is substantially passed through to said housing.
